(19) United States
(12) Patent Application Publication
(10) Pub. No.: US 2005/0132577 A1
(43) Pub. Date: Jun. 23, 2005

(54) Sheet metal penetrating tool

(76) Inventor: Reid Henriksen, Tofield (CA)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 11/044,497

(22) Filed: Jan. 27, 2005

(30) Foreign Application Priority Data
Dec. 5, 2003 (CA) 2,449,152

(51) Int. Cl. B25D 3/00

(52) U.S. Cl. 30/167; 30/168

(57) ABSTRACT

A sheet metal penetrating tool includes an elongated blade having a first end and a second end. The blade is wedge shaped in cross-section. A handle is positioned at the first end of the blade. A piercing tip is positioned at the second end of the blade.

### FIELD OF THE INVENTION

The present invention relates to a penetrating tool developed for use by persons working with sheet metal ducting.

### BACKGROUND OF THE INVENTION

When plans call for a secondary duct to branch off of a primary duct, sheet metal workers must create an opening in the primary duct large enough to permit the insertion of metal snips. Such openings are currently being formed using a screwdriver or a chisel, as there is not a sheet metal penetrating tool suited for this purpose.

### SUMMARY OF THE INVENTION

What is required is a sheet metal penetrating tool suited for making openings in existing ducting or light gauge metal.

According to the present invention there is provided a sheet metal penetrating tool, which includes an elongated blade having a first end and a second end. The blade is wedge shaped in cross-section. A handle is positioned at the first end of the blade. A piercing tip is positioned at the second end of the blade.

With the sheet metal penetrating tool, as described above, an axial force can be exerted upon the handle to cause the piercing tip to pierce sheet metal. A lateral force can then be exerted upon the handle to cause the wedge shaped blade to enlarge the opening in the sheet metal created by the piercing tip.

Although beneficial results may be obtained through use of the sheet metal penetrating tool, as described above, even more beneficial results may be obtained when the handle has a remote anvil end, which is adapted to serve as a striking surface for a hammer. This enables a force to be exerted, by a hammer striking the anvil end, to drive the piercing tip through sheet metal.

Although beneficial results may be obtained through use of the sheet metal penetrating tool, as described above, even more beneficial results may be obtained when the wedge shaped blade has an anvil edge opposed to a cutting edge. The anvil edge is adapted to serve as a striking surface for a hammer. This enables a force to be exerted, by a hammer striking the anvil edge, to drive the cutting edge through sheet metal.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a perspective view of a sheet metal penetrating tool constructed in accordance with the teachings of the present invention.

FIG. 2 is a right side elevation view of the sheet metal penetrating tool illustrated in FIG. 1, the left side elevation view being a mirror image view.

FIG. 3 is a top plan view of the sheet metal penetrating tool illustrated in FIG. 1.

FIG. 4 is a bottom plan view of the sheet metal penetrating tool illustrated in FIG. 1.

FIG. 5 is an end elevation view of a handle end of the sheet metal penetrating tool illustrated in FIG. 1.

FIG. 6 is an end elevation view of a piercing tip end of the sheet metal penetrating tool illustrated in FIG. 1.

FIG. 7 is a side view of the sheet metal penetrating tool piercing sheet metal.

FIG. 8 side view of the sheet metal penetrating tool cutting sheet metal.

### DETAILED DESCRIPTION OF THE PREFERRED EMBODIMENT

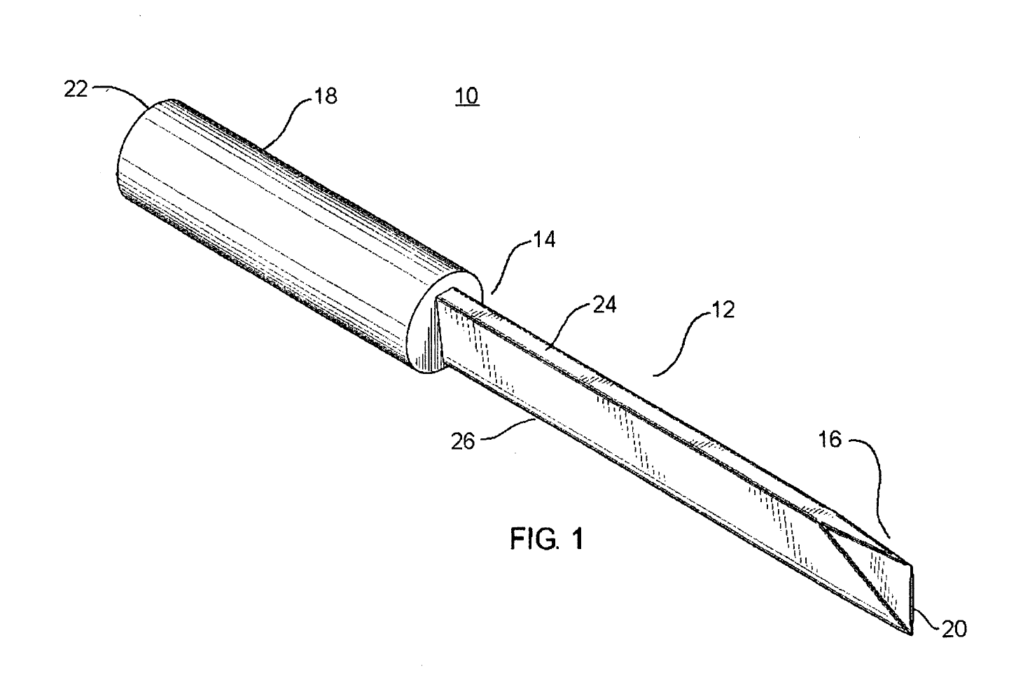

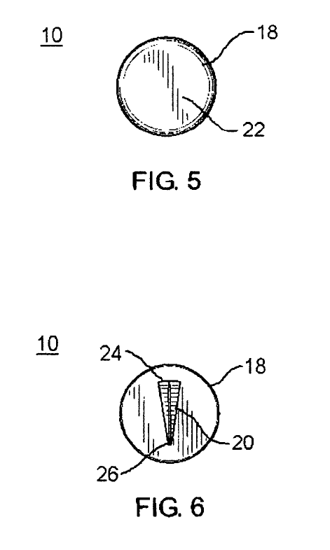

The preferred embodiment, a sheet metal penetrating tool generally identified by reference numeral 10, will now be described with reference to FIGS. 1 through 8.

Structure and Relationship of Parts:

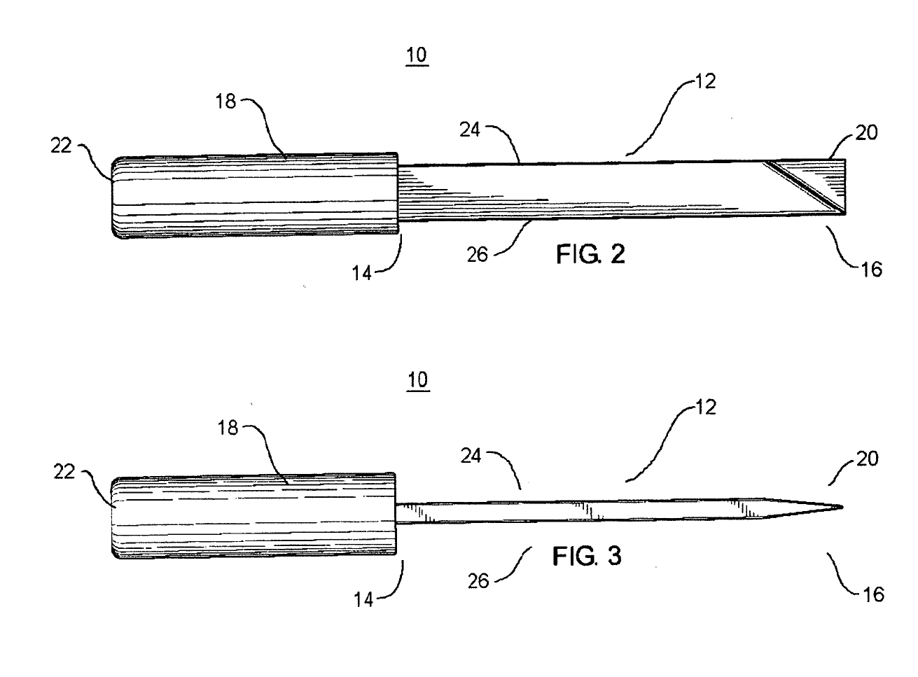

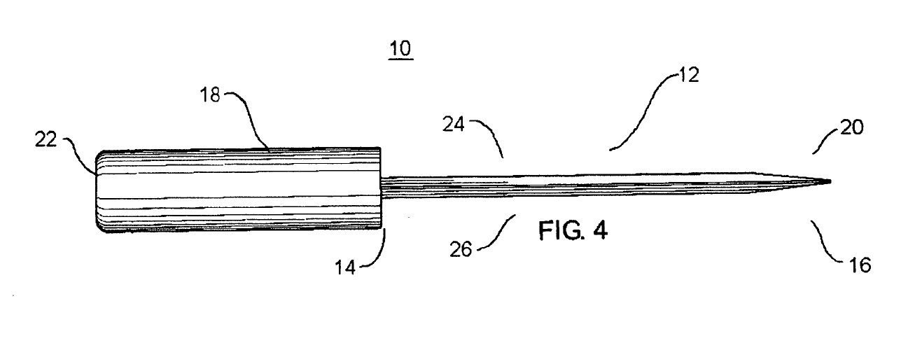

Referring now to FIG. 1, there is shown a sheet metal penetrating tool 10. The sheet metal penetrating tool has an elongated blade 12 having a first end 14 and a second end 16. Referring to the end elevation view in FIG. 6, the blade is shown to be wedge shaped in cross-section. Referring again to FIG. 1, the sheet metal penetrating tool 10 also comprises a handle 18 at the first end 14 of the blade 12 and a piercing tip 20 at the second end 16 of the blade 12. The handle 18 of the sheet metal penetrating tool 10 has a remote anvil end 22 which is adapted to serve as a striking surface for a hammer, whereby a force is exerted to drive the piercing tip 20 through sheet metal. The piercing tip 20 is shown to comprise the width of the blade 12. It should be understood that other shapes, such as a taper to a point, are not excluded. Referring to FIG. 2, the wedge shaped blade 12 has an anvil edge 24 opposed to a cutting edge 26. The anvil edge 24, as shown in FIG. 3, is adapted to serve as a striking surface for a hammer, whereby a force is exerted to drive the cutting edge 26, shown in FIG. 4, through sheet metal.

Operation:

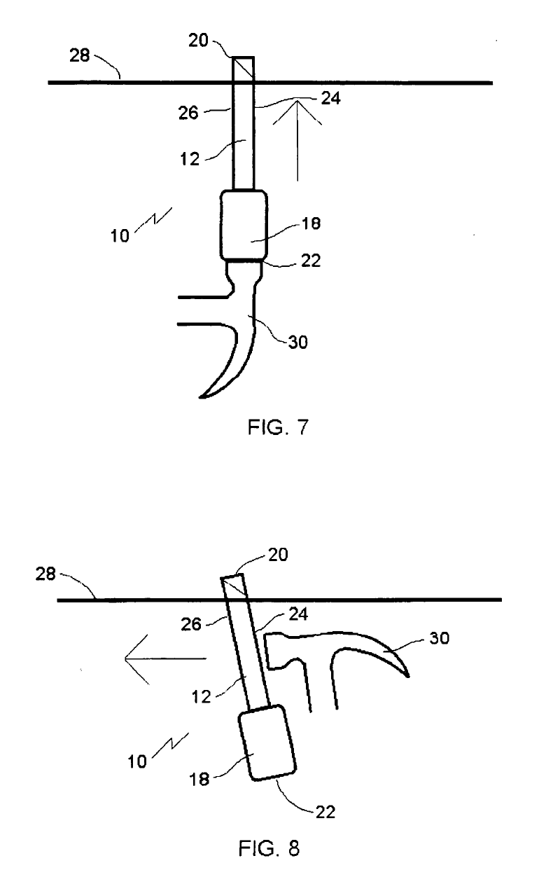

Referring to FIG. 7, the sheet metal penetrating tool 10 is placed against sheet metal 28 in a desired location. The remote anvil end 22 of the handle 18 is struck with a hammer 30, driving the piercing tip 20 through the sheet metal 28. Referring to FIG. 8, the cutting edge 26 of the wedge shaped blade 12 is driven through the sheet metal 28 by a hammer 30 striking the anvil edge 24 of the wedge shaped blade 12 to perform the desired cut.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

1. A sheet metal penetrating tool, comprising:
an elongated blade having a first end and a second end, the blade being wedge shaped in cross-section;
a handle at the first end of the blade; and
a piercing tip at the second end of the blade.

2. The sheet metal penetrating tool as defined in claim 1, wherein the handle has a remote anvil end which is adapted to serve as a striking surface for a hammer, whereby a force is exerted to drive the piercing tip through sheet metal.

3. The sheet metal penetrating tool as defined in claim 1, wherein the wedge shaped blade has an anvil edge opposed to a cutting edge, the anvil edge being adapted to serve as a striking surface for a hammer, whereby a force is exerted to drive the cutting edge through sheet metal.
